(19) United States
(12) Patent Application Publication
(10) Pub. No.: US 2026/0208898 A1
(43) Pub. Date: Jul. 23, 2026

(54) DEVICE FOR BANDING PRODUCTS

(71) Applicant: DUTCH BANDING COMPANY B.V., PS De Meern (NL)

(72) Inventor: Abraham Henricus VAN ROOSMALEN, PS De Meern (NL)

(73) Assignee: DUTCH BANDING COMPANY B.V., PS De Meern (NL)

(21) Appl. No.: 19/140,858

(22) PCT Filed: Dec. 21, 2023
(86) PCT No.: PCT/NL2023/050680

§ 371 Date: Jun. 18, 2025

(30) Foreign Application Priority Data
Dec. 21, 2022 (NL) 2033777

(51) Int. Cl. B65B 13/18; B65B 13/10; B65B 41/16

(52) U.S. Cl. CPC B65B 13/18; B65B 13/10; B65B 41/16

(57) ABSTRACT

Device for banding products, comprising a feed mechanism for feeding band material from a supply roll to wrapping means in a feed direction for the purpose of forming in an end part of the band material a loop around a space for receiving products, wherein the feed mechanism comprises transport means for clamping the band material over a part of its length and transporting it to the wrapping means in guided manner, and drive means for driving the transport means. The device further comprises a folding mechanism arranged between the supply roll and the wrapping means and configured to fold the band material in its longitudinal direction while it is being transported to the wrapping means.

The present invention relates to a device for banding products, particularly a device for banding products, comprising a feed mechanism for feeding band material from a supply roll to wrapping means in a feed direction for the purpose of forming in an end part of the band material a loop around a space for receiving products, wherein the feed mechanism comprises transport means for clamping the band material over a part of its length and transporting it to the wrapping means in guided manner, and drive means for driving the transport means.

Banding comprises of arranging a wrapper, which is also referred to as banderole, around one or more products. A banderole is arranged, among other reasons, to bundle a plurality of products, to impart strength to one or more products and/or, as information carrier, to display information regarding the product. Banding machines generally form a loop of band material around a product, wherein the loop is then tightened in order to arrange the banderole more tightly or less tightly around the product with a determined band tension.

A banderole is generally a thin band of paper or film and can be used both printed and unprinted. An advantage of banding is that products can be bundled, labelled and/or sealed in sustainable manner with just one strip of paper or film. Banding is an inter alia sustainable packaging technique, since a packaging material saving of up to 80% can thereby be achieved compared to conventional packaging techniques, and because the banderole is generally made of a sustainable material such as paper.

Owing to the properties of its material, the small thickness and great flexibility, a banderole is typically suitable for bundling products which may or may not be sensitive to pressure, wherein the expected tensile forces are smaller than 100-300 N, all this depending on the material of the banderole and the thickness thereof. If the expected tensile forces are greater than 300 N, there is a high risk the banderole giving out.

A known alternative to bundling with a banderole with expected tensile forces of more than 300 N is strapping with so-called strapping band. Large stacks of newspapers are typically bundled with strapping band. Strapping band is able to withstand great tensile forces (of up to as much as 1000 N), but strapping is generally less sustainable than banding due to the material of the strapping band, this usually containing plastics. Typical strapping bands are made of polyester (PET) or polypropylene (PP).

It is an object of the present invention to provide an alternative to strapping band, which also has the advantages of a banderole.

For this purpose the present invention provides a device of the type stated in the preamble, with the special feature that the device further comprises a folding mechanism arranged between the supply roll and the wrapping means and configured to fold the band material in its longitudinal direction while it is being transported to the wrapping means. Since the side edges of the strip which extend in longitudinal direction of the strip are folded by the folding mechanism, the side edges of the strip are formed in folded state by folded-over band material. The folds resulting from the folding on either side of the strip give the strip a considerably higher tear resistance than a strip of non-folded band material. The tensile strength of the strip is also increased in that the strip consists over at least a portion of the width of the strip of a double layer of band material. At the same time, the advantages of the known banderole are preserved, such as the sustainability of the material and its function as information carrier.

In a preferred embodiment of the device according to the present invention the folding mechanism is configured to fold the band material along its length at each of its two opposite long side edges. The folding mechanism is preferably configured to fold the band material along its length at each of its two opposite long side edges such that free outer ends of the band material extending in the longitudinal direction of the band material are directed toward each other. In other words: the folding mechanism folds the edges of the strip toward each other so that the folded portions of the strip are located on a side of the strip. When banding with the folded strip it is in this way possible to ensure that the folded portions are located on the inner side of the banderole to be arranged, which has the advantage that the folded portions do not unfold when the banderole is arranged around the products. The folding mechanism is preferably configured to fold the band material along its length at each of its two opposite long side edges along respectively a first fold line and a second fold line, wherein the first and second fold line extend in the longitudinal direction of the band material and wherein the first and the second fold line differ from each other.

In a further preferred embodiment the folding mechanism is configured to fold the band material along its length at each of its two opposite long side edges such that, at least seen in a non-folded state of the band material, each of the first fold line and the second fold line is located closer to its respective nearest long side edge of the band material than to the centre line of the band material extending in the longitudinal direction of the band material. In this way the above described technical advantage of the folded side edges is obtained and, at the same time, this results in the visible portion of the banderole to be arranged, i.e. the non-folded central portion of the strip, remaining relatively wide, whereby sufficient space remains for printing information on said visible portion.

In a preferred embodiment the band material is made substantially of paper, wherein the thickness of the paper lies between about 90 μm and about 160 μm, and the folding mechanism is configured to fold the band material in its longitudinal direction such that, as seen in cross-section in the longitudinal direction of the band material, the band material is U-shaped at the position from where the band material is bent, wherein a minimal radius of curvature of a portion of the band material extending between legs of the U is greater than 10 μm, preferably greater than 50 μm, and more preferably greater than 100 μm. The greater the radius of curvature of the fold, the greater the tear resistance of the folded strip. A greater tear resistance of the strip enables bundles with a higher weight to be wrapped with the strip and to be transported with an acceptably low risk of the strip tearing all the way through.

In a preferred embodiment the folding mechanism comprises a base plate for carrying the band material thereover and a guide member arranged opposite the base plate and having a guide surface directed toward the base plate, wherein the band material is carried along the guide surface between the base plate and the guide surface. The folding mechanism further comprises a pair of walls standing upright relative to the base plate and extending mutually parallel in the direction of the band material. The guide member is arranged between the upright walls close to an upstream end surface of the upright walls. A mutual distance between the upright walls is smaller than a width of the band material. The guide member is arranged such that the band material moves along the guide surface and is guided between upright walls while it is being fed, wherein the upright walls fold the band material against opposite side edges of the guide member along its length at each of its two opposite long side edges at a respective fold line, such that said long side edges of the band material move toward a surface of the guide member which is directed away from the guide surface.

In a preferred embodiment the transport means comprise a conveyor belt and the folding mechanism comprises a plate-like guide member with a flat guide surface for guiding the band material therealong, wherein the band material is transported along the guide surface between the conveyor belt and the guide surface, and a first pair of folding rollers, wherein the plate-like guide member is substantially rectangular and extends substantially in the longitudinal direction of the band material, has a width which is narrower than the width of the band material, and is arranged such that the band material moves along the guide surface and is guided toward the first pair of folding rollers while it is being fed, and wherein each of the first pair of folding rollers takes a form and is arranged relative to the plate-like guide member such that the first pair of folding rollers fold the band material against opposite side edges of the plate-like guide member along its length at each of its two opposite long side edges at a respective fold line, such that said long side edges of the band material move toward a second surface of the plate-like guide member which is directed away from the guide surface.

In a further preferred embodiment each of the first pair of folding rollers takes a form and is arranged relative to the plate-like guide member such that the folding rollers fold said long side edges of the band material against side edges of the plate-like guide member such that folded parts of the band material extend substantially perpendicularly of the longitudinal direction of the band material.

In a preferred embodiment the folding mechanism further comprises a second pair of folding rollers which, as seen in the feed direction of the band material, is arranged downstream relative to the first pair of folding rollers, wherein outer surfaces of end parts of each of the second pair of folding rollers directed toward the plate-like guide member are conical in order to fold the band material further at each respective folding line, wherein said conical end parts of the second pair of folding rollers are located on the side of but not necessarily directly above the second surface of the plate-like guide member, are directed toward each other and extend inward relative to long side edges of the plate-like guide member.

In a preferred embodiment the folding mechanism further comprises a third pair of folding rollers which, as seen in the feed direction of the band material, is arranged downstream relative to the second pair of folding rollers, wherein outer surfaces of end parts of each of the third pair of folding rollers directed toward the plate-like guide member are conical in order to fold the band material still further at each respective folding line, wherein said conical end parts of the third pair of folding rollers are located on the side of but not necessarily directly above the second surface of the plate-like guide member, are directed toward each other, and extend inward relative to long side edges of the plate-like guide member, wherein the conicity of the folding rollers of the third pair is smaller than that of the folding rollers of the second pair, and wherein the end parts of the folding rollers of the third pair are located closer to the conveyor belt than those of the folding rollers of the second pair.

In a preferred embodiment the folding mechanism further comprises a second plate-like guide member which, as seen in the feed direction of the band material, is arranged downstream relative to the third pair of folding rollers, having a flat guide surface for guiding the band material therealong, wherein the band material is transported along the guide surface of the second plate-like guide member between the conveyor belt and the guide surface of the second plate-like guide member, wherein the distance between the guide surface of the second plate-like guide member and the surface of the conveyor belt directed toward said guide surface is such that the band material is folded more sharply at each respective fold line.

In further or alternative preferred embodiments the folding rollers of the first pair and/or the folding rollers of the second pair and/or the folding rollers of the third pair are located substantially opposite each other.

In a further preferred embodiment the device further comprises means for cutting off the end part and means for closing the loop. The means for closing the loop preferably comprise splicing means for mutually connecting end parts of the loop by means of splicing.

The present invention is further elucidated with reference to the following figures, which are not intended to limit the scope of protection of the invention in any way, wherein:

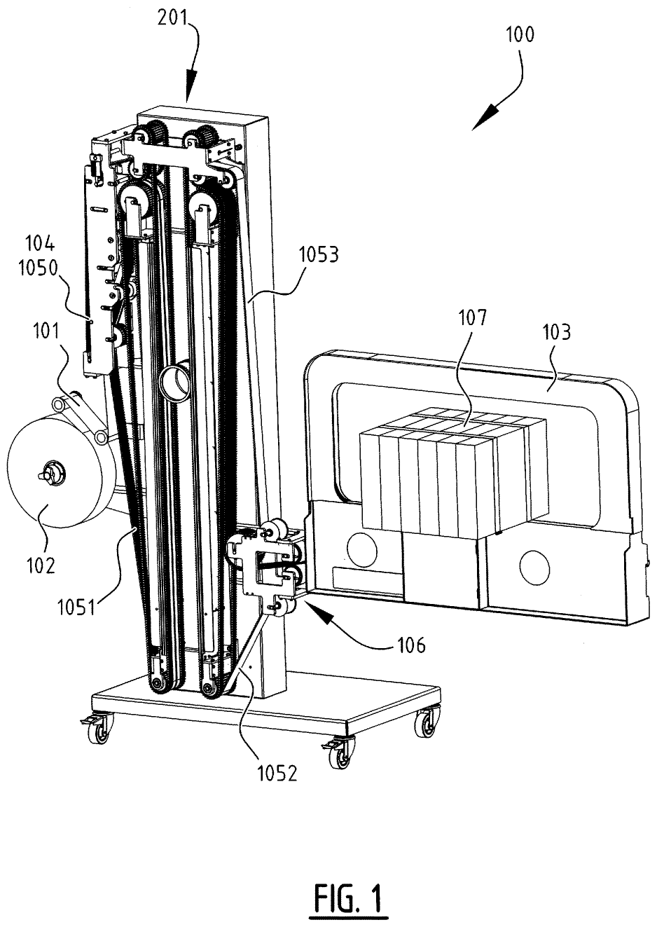

FIG. 1 shows a preferred embodiment of the device according to the present invention;

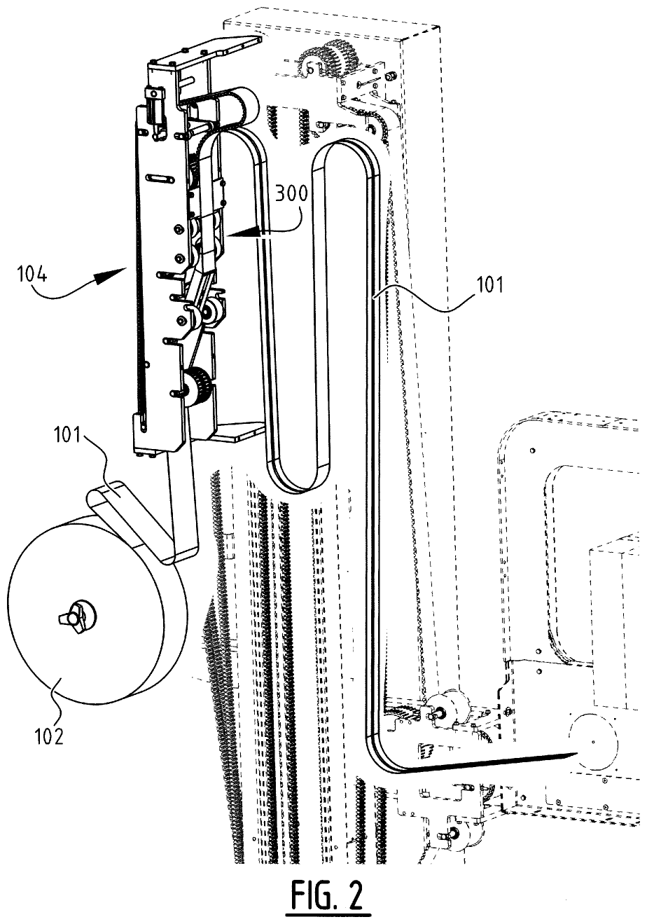

FIG. 2 shows the folding mechanism of the preferred embodiment of the device shown in FIG. 1 with band material arranged therein in full lines;

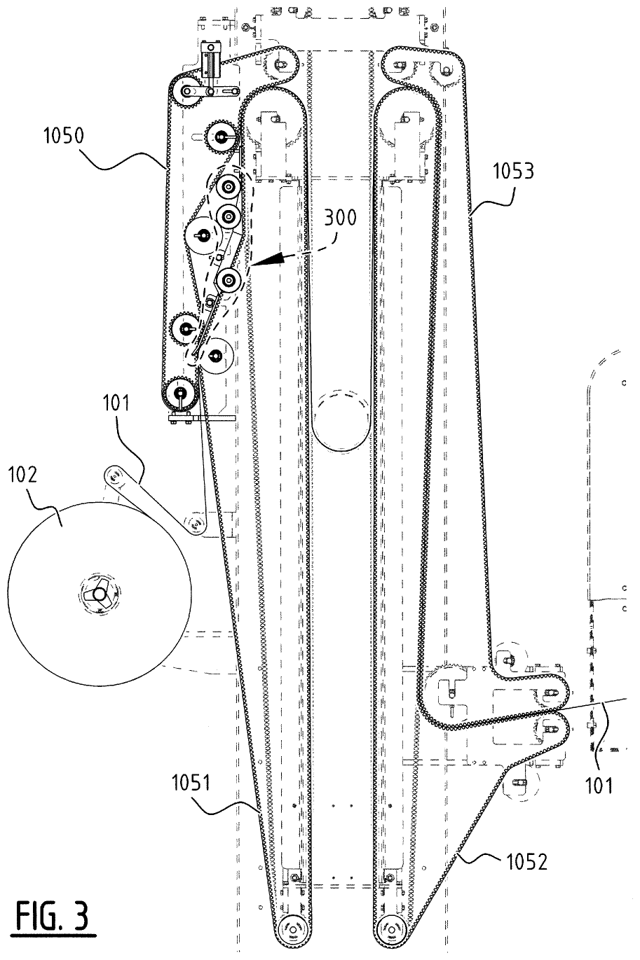

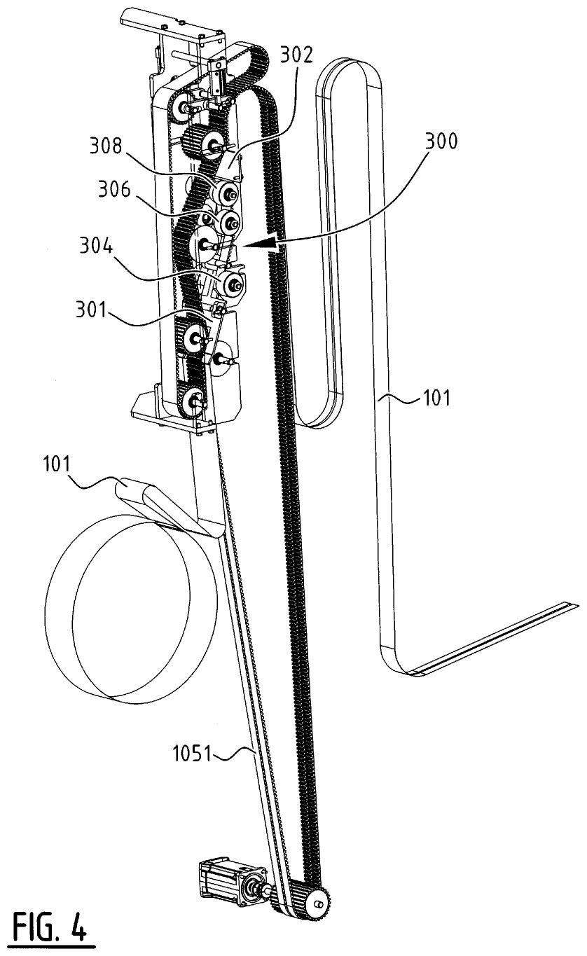

FIG. 3 shows a cross-section of FIG. 2 in side view;

FIG. 4 shows the folding mechanism shown in FIG. 2 in cut-away state from a different perspective;

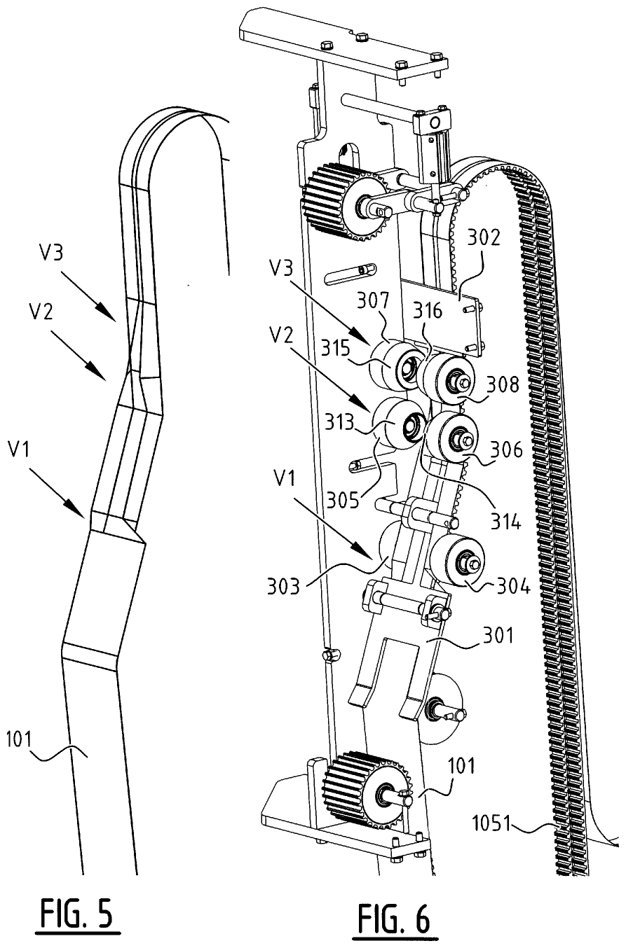

FIG. 5 shows schematically the state of the band material at the position of the folding mechanism;

FIG. 6 shows a perspective view of the folding mechanism;

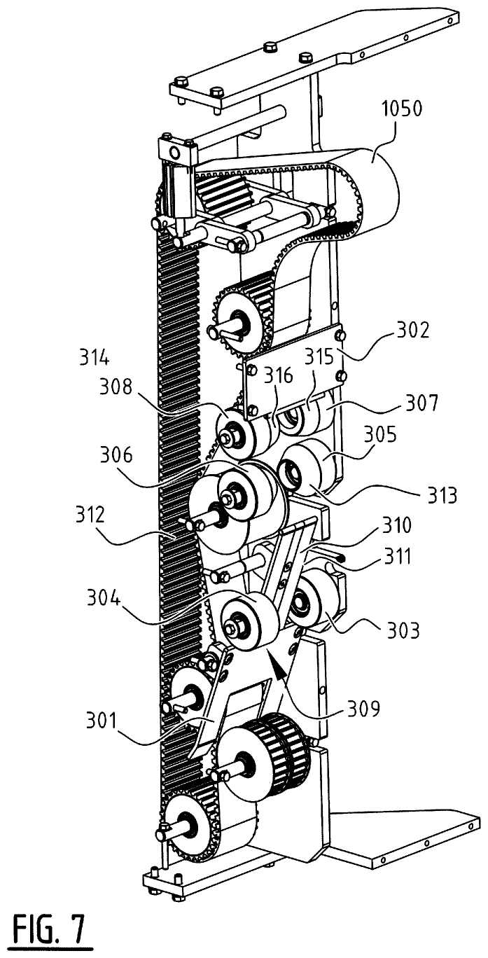

FIG. 7 shows a perspective view of the folding mechanism differing from the view of FIG. 6.

FIG. 1 shows a perspective view of a banding machine 100. The banding machine 100 carries band material 101, substantially of paper, from a supply roll 102, through the machine 100 and to wrapping means in the form of a banding arch 103. In its path toward the banding arch 103 the band material 101 is successively carried through a first feed mechanism 104, guided through a buffer mechanism 201 and carried by an arch feed mechanism 106 to banding arch 103. The banding arch 103 then forms a loop of band material 101 around a product 107 to be banded.

Finally, the loop of band material 101 is closed under the product 107, for instance by means of an adhesive connection, and the closed loop is cut off from the upstream band material 101 by cutting means.

It is inherent to the banding process that more band material 101 is always reeled into banding arch 103 than is needed for banding of product 107. This is because product 107 is always smaller than the inner periphery of banding arch 103. The moment that band material 101 is tightened around product 107, the pulled-back excess band material 101 is buffered in a buffer space 210 by a buffer mechanism 201. For banding of a subsequent product it is necessary for the used band material 101 around product 107 to be fed from supply roll 102 again.

For feeding and pulling back band material 101 the arch feed mechanism 106 can transport the band material 101 in two mutually opposite directions, whereby band material 101 can be pulled back in order to tighten the loop of band material 101 formed by banding arch 103 around product 107 to be banded, before the loop is closed.

The path of band material 101 through first feed mechanism 104 toward arch feed mechanism 106 via buffer mechanism 201 is shown in FIGS. 1 and 2. Band material 101 is introduced through first feed mechanism 104 on the left-hand side of buffer mechanism 201. Band material 101 is here introduced between two toothed belts 1050 and 1051, wherein the backs of the toothed belts 1050 and 1051 transport band material 101 to buffer mechanism 201. Downstream of buffer mechanism 201 the band material 101 crosses over to a second set of toothed belts 1052 and 1053 and is carried to the banding arch 103.

In order to fold band material 101 the feed mechanism 104 comprises a folding mechanism 300. In the folding mechanism 300 the band material 101 is transported over a first guide plate 301 to a plurality of sets of folding rollers. The folding rollers fold band material 101 increasingly inward on itself, and downstream of the folding rollers, as seen in the transport direction of band material 101 through feed mechanism 104, the folded band material 101 passes a second flat guide plate 302 against which the folded band material 101 is pressed by the back of toothed belt 1051 in order to press down the folds.

The sets of folding rollers comprise in succession, as seen in the transport direction of band material 101 through feed mechanism 104, a first pair of folding rollers 303, 304, a second pair of folding rollers 305, 306 and a third pair of folding rollers 307, 308. Guide plate 301 has a flat guide surface 309 along which band material 101 is guided, such that band material 101 is transported along guide surface 309 between the back of conveyor belt 1051 and guide surface 309.

As shown in FIGS. 6 and 7, the flat guide plate 301 is substantially rectangular and extends substantially in the longitudinal direction of band material 101. The portion of guide plate 301 located close to the first pair of folding rollers 303, 304 has a width which is narrower than the width of band material 101. The narrower portion 310 of guide plate 301 is in this respect referred to in the following. Guide plate 301 is arranged such that band material 101 moves along guide surface 309 and is guided to the first pair of folding rollers 303, 304 while it is being transported to banding arch 103. The smaller width of the narrower portion 310 of guide plate 301 close to the first pair of folding rollers 303, 304 ensures that the folding rollers of the first pair of folding rollers 303, 304 fold the band material 101 against opposite side edges 311, 312 of the narrower portion 310 of guide plate 301 along its length at each of its two opposite long side edge at a respective fold line (see V1).

Each of the first pair of folding rollers 303, 304 is arranged relative to guide plate 301 such that the folding rollers 303, 304 fold said long side edges of band material 101 against side edges 311, 312 of the narrower portion 310 of guide plate 301 such that folded parts 401, 402 of band material 101 extend substantially perpendicularly of the longitudinal direction of band material 101.

The folding mechanism 300 further comprises a second pair of folding rollers 305, 306. The folding rollers of this second pair of folding rollers 305, 306 are located, as seen in the feed direction of band material 101, downstream relative to the first pair of folding rollers 303, 304 and are configured to fold band material 101 further at the fold lines arranged by the first folding rollers 303, 304 (see V2). Outer surfaces of end parts 313, 314 of each of the second pair of folding rollers 305, 306 directed toward the guide plate are conical and extend inward relative to long side edges 311, 312 of the narrower portion 310 of guide plate 301.

Folding mechanism 300 further comprises a third pair of folding rollers 307, 308. The folding rollers of this third pair of folding rollers 307, 308 are located, as seen in the feed direction of band material 101, downstream relative to the second pair of folding rollers 305, 306 and are configured to fold band material 101 further at the fold lines arranged by the first and the second folding rollers (see V 3). Outer surfaces of end parts 315, 316 of each of the third pair of folding rollers 307, 308 directed toward the guide plate are also conical and extend inward relative to long side edges 311, 312 of the narrower portion 310 of guide plate 301. The conicity of the folding rollers 307, 308 of the third pair is smaller than that of the folding rollers 305, 306 of the second pair. The end parts 315, 316 of the folding rollers 307, 308 of the third pair are also located closer to conveyor belt 1051 than those of the folding rollers 305, 306 of the second pair. As shown in FIGS. 6 and 7, the folding rollers 303, 304 of the first pair, the folding rollers 305, 306 of the second pair and the folding rollers 307, 308 of the third pair are located opposite each other.

Finally, the folded band material 101 passes a second flat guide plate 302, against which the folded band material 101 is pressed by the back of toothed belt 1051 in order to press down the folds.

The folds on either side of the paper band material 101 realized by the folding mechanism give the band material 101 a considerably higher tear resistance than non-folded paper band material. The tensile strength of band material 101 is also increased in that the band material consists of a double layer of band material over at least a portion of the width of the band material. At the same time, the advantages of the known banderole are preserved, such as the sustainability of the material and its function as information carrier.

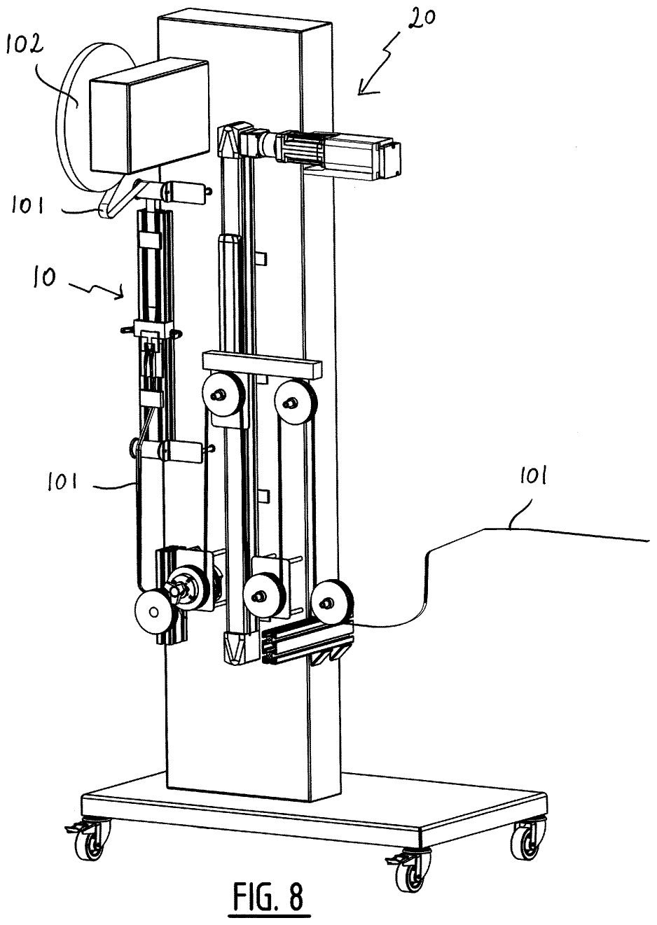

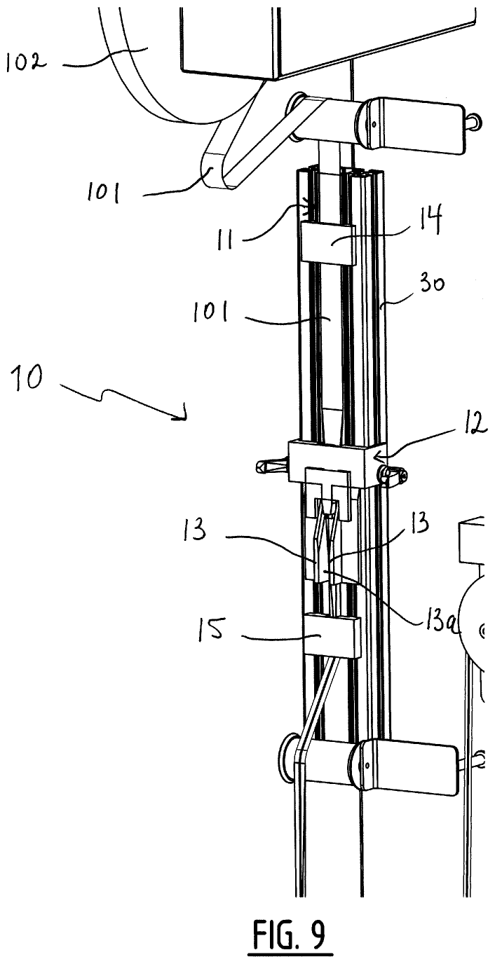

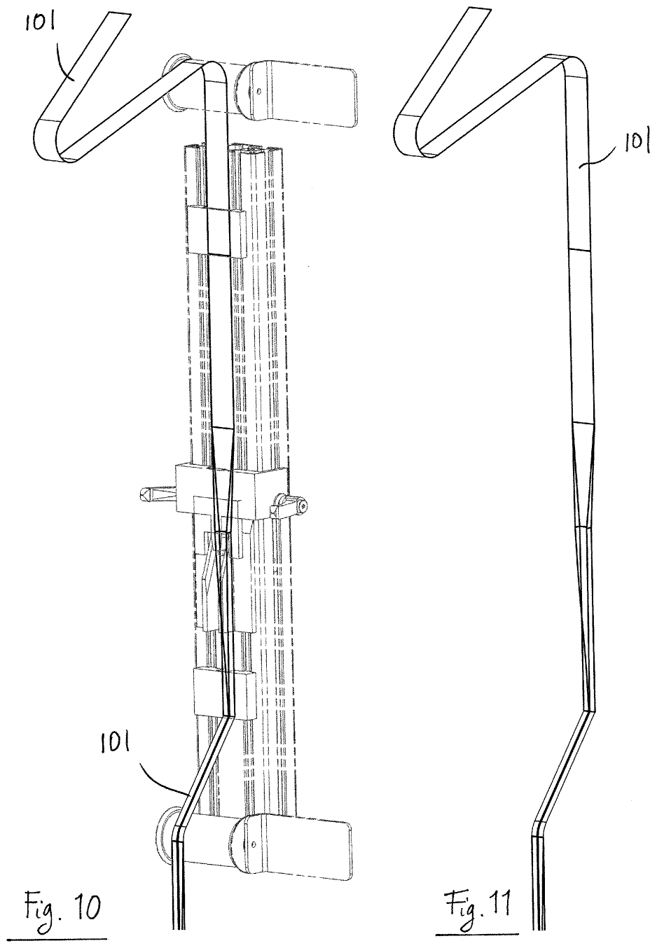

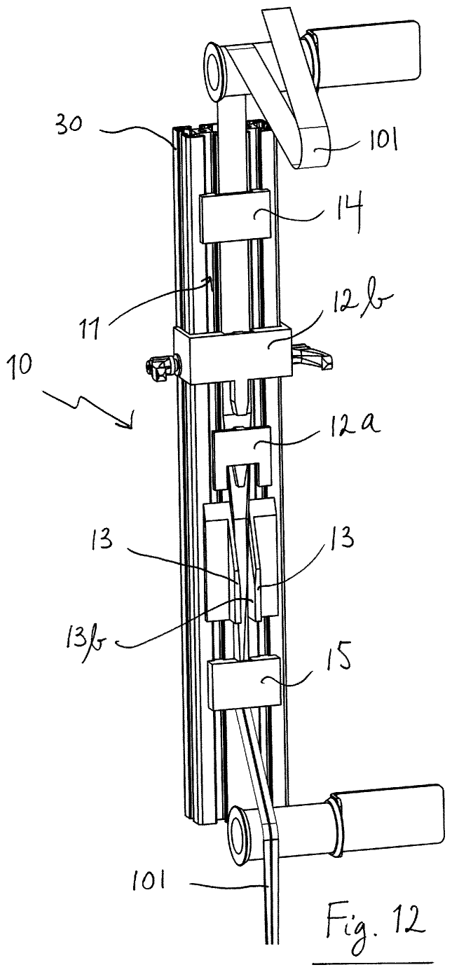

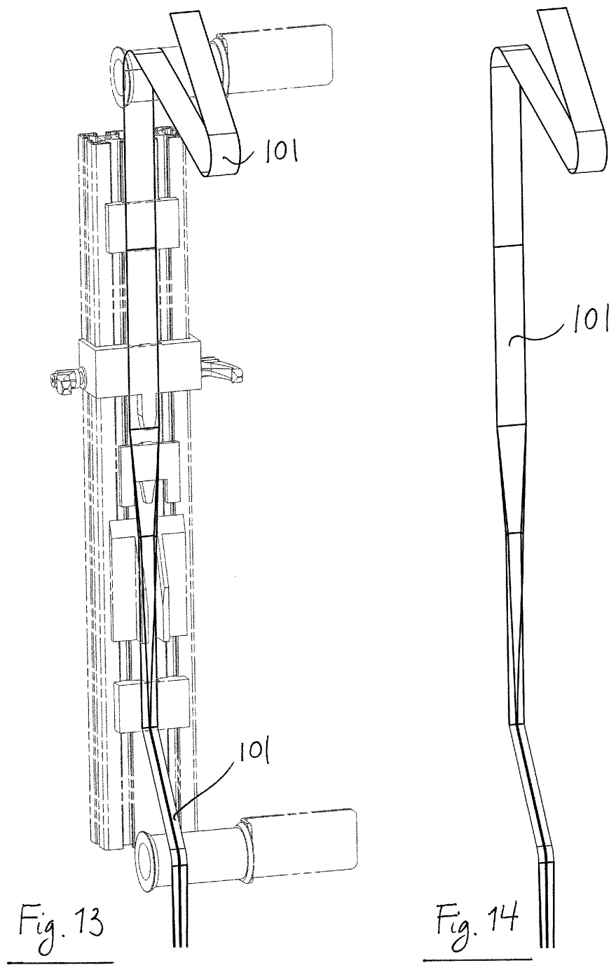

An assembly of an alternative buffer mechanism 20 and an alternative folding mechanism 10 is shown in FIG. 8. The folding mechanism 10 comprises a profile 30 with a base plate 11 for carrying the band material 101 thereover, and a guide member 12 arranged opposite the base surface 11 and having a guide surface directed toward base surface 11, wherein band material 101 is carried along the guide surface between base surface 11 and the guide surface. Folding mechanism 10 further comprises a pair of walls 13 standing upright relative to the base surface and extending mutually parallel in the direction of the band material 101. The guide member 12 is arranged between the upright walls 13 close to an upstream end surface of upright walls 13. A mutual distance between the upright walls is smaller than a width of band material 101. Guide member 12 is arranged such that band material 101 moves along the guide surface and is guided between upright walls 13 while it is being fed, wherein upright walls 13 fold band material 101 against opposite side edges of guide member 12 along its length at each of its two opposite long side edges at a respective fold line, such that said long side edges of band material 101 move toward a surface of guide member 12 directed away from the guide surface. As shown in FIGS. 12 and 13, guide member 12 consists of two guide part 12a and 12b. While guide part 12a provides for the formation of the fold, guide part 12b provides for the guiding of de parts of band material 101 folded by guide part 12a along the inner surfaces 13a and 13b of upright walls 13. Before band material 101 reaches guide member 12, i.e. upstream relative to guide member 12, a flat plate 14 is located opposite base surface 11. Band material 101 is carried between this flat plate 14 and base surface 11, wherein the flat plate 14 ensures that the band material 101 moves flat over base surface 11 before band material 101 reaches guide member 12. This provides for a correct operation of guide member 12 and the upright walls 13 co-acting therewith, so that the band material 101 is folded in the desired manner, i.e. along the extending direction of the band material 101 and at the desired distance from the long side edges. Located downstream relative to guide member 12 and upright walls 13 is a second flat plate 15 opposite the base surface 11. The band material 101 partially folded by guide member 12 and upright walls 13 is carried between this second flat plate 15 and base surface 11 in order to fully fold the side edges, folded by guide member 12 and upright walls 13, against the side of band material 101 which is directed away from the side of band material 101 lying against base surface 11. This second flat plate 15 here presses the folded portions of band material 101 against said side of band material 101 directed away from base surface 11.

The present invention is not limited to the shown embodiments but also extends to other embodiments falling within the scope of protection of the appended claims.

1. A device for banding products, comprising:
a feed mechanism for feeding band material from a supply roll to wrapping means in a feed direction for the purpose of forming in an end part of the band material a loop around a space for receiving products, wherein the feed mechanism comprises transport means for clamping the band material over a part of its length and transporting it to the wrapping means in guided manner, and drive means for driving the transport means,
wherein a folding mechanism arranged between the supply roll and the wrapping means and configured to fold the band material in its longitudinal direction while it is being transported to the wrapping means.

2. The device according to claim 1, wherein the folding mechanism is configured to fold the band material along its length at each of its two opposite long side edges.

3. The device according to claim 1, wherein the folding mechanism is configured to fold the band material along its length at each of its two opposite long side edges such that free outer ends of the band material extending in the longitudinal direction of the band material are directed toward each other.

4. The device according to claim 1, wherein the folding mechanism is configured to fold the band material along its length at each of its two opposite long side edges along respectively a first fold line and a second fold line, wherein the first and second fold line extend in the longitudinal direction of the band material and wherein the first and the second fold line differ from each other.

5. The device according to claim 4, wherein the folding mechanism is configured to fold the band material along its length at each of its two opposite long side edges such that, at least seen in a non-folded state of the band material, each of the first fold line and the second fold line is located closer to its respective nearest long side edge of the band material than to the centre line of the band material extending in the longitudinal direction of the band material.

6. The device according to claim 1, wherein the band material is made substantially of paper, wherein the thickness of the paper lies between about 90 μm and about 160 μm, and wherein the folding mechanism is configured to fold the band material in its longitudinal direction such that, as seen in cross-section in the longitudinal direction of the band material, the band material is U-shaped at the position from where the band material is bent, wherein a minimal radius of curvature of a portion of the band material extending between legs of the U is greater than 10 μm, preferably greater than 50 μm, and more preferably greater than 100 μm.

7. The device according to claim 1, wherein the folding mechanism comprises:
a base plate for carrying the band material thereover and a guide member arranged opposite the base plate and having a guide surface directed toward the base plate, wherein the band material is carried along the guide surface between the base plate and the guide surface, and
a pair of walls standing upright relative to the base plate and extending mutually parallel in the direction of the band material,
wherein the guide member is arranged between the upright walls close to an upstream end surface of the upright walls, wherein a mutual distance between the upright walls is smaller than a width of the band material, wherein the guide member is arranged such that the band material moves along the guide surface and is guided between upright walls while it is being fed, wherein the upright walls fold the band material against opposite side edges of the guide member along its length at each of its two opposite long side edges at a respective fold line, such that said long side edges of the band material move toward a surface of the guide member which is directed away from the guide surface.

8. The device according to claim 1, wherein the transport means comprise a conveyor belt, and wherein the folding mechanism comprises:
a plate-like guide member with a flat guide surface for guiding the band material therealong, wherein the band material is transported along the guide surface between the conveyor belt and the guide surface, and
a first pair of folding rollers,
wherein the plate-like guide member is substantially rectangular and extends substantially in the longitudinal direction of the band material, has a width which is narrower than the width of the band material, and is arranged such that the band material moves along the guide surface and is guided toward the first pair of folding rollers while it is being fed, and
wherein each of the first pair of folding rollers takes a form and is arranged relative to the plate-like guide member such that the first pair of folding rollers fold the band material against opposite side edges of the plate-like guide member along its length at each of its two opposite long side edges at a respective fold line, such that said long side edges of the band material move toward a second surface of the plate-like guide member which is directed away from the guide surface.

9. The device according to claim 8, wherein each of the first pair of folding rollers takes a form and is arranged relative to the plate-like guide member such that the folding rollers fold said long side edges of the band material against side edges of the plate-like guide member such that folded parts of the band material extend substantially perpendicularly of the longitudinal direction of the band material.

10. The device according to claim 8, wherein the folding mechanism further comprises a second pair of folding rollers which, as seen in the feed direction of the band material, is arranged downstream relative to the first pair of folding rollers, wherein outer surfaces of end parts of each of the second pair of folding rollers directed toward the plate-like guide member are conical in order to fold the band material further at each respective folding line, wherein said conical end parts of the second pair of folding rollers are located on the side of but not necessarily directly above the second surface of the plate-like guide member, are directed toward each other and extend inward relative to long side edges of the plate-like guide member.

11. The device according to claim 10, wherein the folding mechanism further comprises a third pair of folding rollers which, as seen in the feed direction of the band material, is arranged downstream relative to the second pair of folding rollers, wherein outer surfaces of end parts of each of the third pair of folding rollers directed toward the plate-like guide member are conical in order to fold the band material still further at each respective folding line, wherein said conical end parts of the third pair of folding rollers are located on the side of but not necessarily directly above the second surface of the plate-like guide member, are directed toward each other and extend inward relative to long side edges of the plate-like guide member,
wherein the conicity of the folding rollers of the third pair is smaller than that of the folding rollers of the second pair, and wherein the end parts of the folding rollers of the third pair are located closer to the conveyor belt than those of the folding rollers of the second pair.

12. The device according to claim 11, wherein the folding mechanism further comprises a second plate-like guide member which, as seen in the feed direction of the band material, is arranged downstream relative to the third pair of folding rollers, having a flat guide surface for guiding the band material therealong, wherein the band material is transported along the guide surface of the second plate-like guide member between the conveyor belt and the guide surface of the second plate-like guide member, wherein the distance between the guide surface of the second plate-like guide member and the surface of the conveyor belt directed toward said guide surface is such that the band material is folded more sharply at each respective fold line.

13. The device according to claim 8, wherein the folding rollers of the first pair are located substantially opposite each other.

14. The device according to claim 10, wherein the folding rollers of the second pair are located substantially opposite each other.

15. The device according to claim 11, wherein the folding rollers of the third pair are located substantially opposite each other.

16. The device according to claim 1, wherein the feed mechanism comprises the folding mechanism.

17. The device according to claim 1, further comprising means for cutting off the end part and means for closing the loop.
